(19) United States
(12) Patent Application Publication
(10) Pub. No.: US 2011/0302060 A1
(43) Pub. Date: Dec. 8, 2011

(54) ORDER PROCESSING AND BENEFIT DISTRIBUTION SYSTEMS AND METHODS

(76) Inventor: Rodrigo Cano, Roswell, GA (US)

(21) Appl. No.: 13/213,062

(22) Filed: Aug. 18, 2011

(51) Int. Cl. G06Q 30/00

(52) U.S. Cl. 705/27.1

(57) ABSTRACT

Computer systems and related methods for encouraging individuals to purchase items and/or services from a retailer. In particular embodiments, a manufacturer of particular items establishes a web site that is used to: (1) store lists of items that are required for participation in a particular group (e.g., a dance class); (2) allow members of the group to: (A) logon to place an order for the items, (B) specify a retailer that they would like to fulfill the order, and (C) specify an entity (e.g., their dance studio) that will benefit from the purchase of the items; (3) forward the order to the specified retailer for fulfillment; (4) receive confirmation from the retailer that the order has been fulfilled; and (5) in response to receiving this confirmation, facilitating the transfer of a particular benefit (e.g., a monetary contribution) to the specified benefitting entity.

### BACKGROUND

Many retailers specializing in selling uniforms for dancers have seen their profits decrease in the recent past due to increased competition from the manufacturers of dance supplies, who have begun using the Internet to sell directly to consumers. Because the manufacturers typically don't have the expense of running and maintaining brick-and-mortar retail stores, they are able to offer lower prices while obtaining higher profit margins than they would receive by selling through their normal network of retailers.

The presence of brick-and-mortar retailers is advantageous to everyone in the dance community. These retailers provide a physical meeting place that allows dancers to handle and try on merchandise, and to interact with others who are also interested in dance. Accordingly, there is a need for new systems and methods to strengthen the role of retailers within the dance community, and to encourage individuals to purchase directly from their local retail stores.

While such a system is described below within the specific context of dance products, the system, or similar systems, may be implemented within the context of other types of products or services.

### SUMMARY OF VARIOUS EMBODIMENTS

A computer system, according to various embodiments, for processing an order for a particular item that is made by a manufacturer and sold by a retailer, comprises memory and at least one computer processor. In certain embodiments, the system is adapted for executing the steps of: (A) receiving, from a representative of a school, a list of one or more items to be used by a student within a particular class as part of the student's involvement with the particular class, the particular class being offered by the school; (B) saving the list of items to memory; (C) displaying the list of one or more items to a purchaser who wishes to purchase the one or more items; (D) allowing the purchaser to place an order for the one or more items; (E) receiving information regarding a benefitting party, the benefitting party being a party who will receive a benefit as a result of the purchaser purchasing the one or more items; (F) transmitting a message to a designated retailer indicating that the purchaser has placed the order; (G) allowing the designated retailer to access information regarding the order so that the retailer may fulfill the order; (H) receiving an indication that the retailer has fulfilled the order; and (I) at least partially in response to receiving the indication that the retailer has fulfilled the order, facilitating a transfer of the benefit to the benefitting party.

A computer system, according to particular embodiments, for processing an order for a particular item that is made by a manufacturer and sold by a retailer, is adapted for: (A) receiving from a consumer, via a web site associated with the manufacturer, the order for the particular item, the order indicating that the consumer wishes to purchase the particular item from the retailer; (B) receiving, from the consumer, an indication of a particular benefitting entity that the consumer wishes to have benefit from the consumer's purchase of the particular item; (C) at least partially in response to receiving the order from the consumer, transmitting a message to the retailer indicating that the order has been received; facilitating access, by the retailer, to specific information regarding the order; (D) receiving an indication that the order has been fulfilled by the retailer; and [symbol] at least partially in response to receiving the indication that the order has been fulfilled by the retailer, facilitating a conveyance of a benefit to the benefitting entity.

A computer-implemented method, according to various embodiments, of distributing a benefit to a benefitting entity comprises the steps of: (A) receiving, from a school representative, a list of one or more items to be used by a student within a particular class as part of the student's involvement with the particular class, the particular class being offered by the school; (B) saving the list of items to computer memory; (C) displaying the list of one or more items to a purchaser who wishes to purchase the one or more items for an individual who is taking the particular class; (D) allowing the purchaser to place an order for the one or more items; (E) receiving information regarding a benefitting party, the benefitting party being a party who will receive a benefit as a result of the purchaser purchasing the one or more items; (F) transmitting a message to a designated retailer indicating that the purchaser has placed the order; (G) allowing the designated retailer to access information regarding the order so that the retailer may fulfill the order; (H) receiving an indication that the retailer has fulfilled the order; and (I) at least partially in response to receiving the indication that the retailer has fulfilled the order, facilitating a transfer of a benefit to the benefitting party.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a system according to one embodiment.

FIG. 2 is a block diagram of the Order Processing and Benefit Distribution Server of FIG. 1.

FIG. 3 depicts a flowchart of an Order Requirements Entry Module according to a particular embodiment.

FIG. 4 depicts a flowchart of an Order Processing Module according to a particular embodiment.

FIG. 5 depicts a flowchart of a Benefit Distribution Module according to a particular embodiment.

FIG. 6 depicts a flowchart of a Reporting Module according to a particular embodiment.

FIG. 7 depicts a flowchart of a Schedule Display Module according to a particular embodiment.

FIG. 8 is a screen display according to a particular embodiment that shows a fundraising program home screen according to a particular embodiment.

FIG. 9 is a screen display according to a particular embodiment that shows a School/Group login screen according to a particular embodiment.

FIG. 10A shows the upper portion of a school profile screen according to a particular embodiment.

FIG. 10B shows the lower portion of a school profile screen according to a particular embodiment.

FIG. 11 shows a class setup screen according to a particular embodiment.

FIG. 12 shows a dancer login screen according to a particular embodiment.

FIG. 13 is a benefit reporting screen according to a particular embodiment.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In various embodiments, an order processing and benefit distribution system is provided in which: (1) a dance instructor, or other dance school representative, logs on to the web site of a dance product manufacturer where the dance instructor: (a) specifies their dance school, the name and/or number of each of their classes, and the schedule of each class; (b) specifies the items that make up the uniform for each of the dance instructor's classes; and (c) optionally lists preferred retailers from which the uniform for each class may be purchased; (2) the dance instructor then asks their students to log on to the manufacturer's web site to obtain their uniform requirements and order their uniforms; (3) each student then logs on to the manufacturer's web site and enters their class information; (4) the manufacturer's web site then displays the various items that make up the student's class uniform; (5) the student may then place an order for their class uniform (and/or other items) by: (a) selecting the items that they wish to purchase; (b) selecting (e.g., via a drop down menu) a retailer from which they wish to purchase the items; (c) indicating which entity (e.g., the student's dance school) they would like to have benefit from their purchase of the items; (d) indicating whether they would like to pick the items up from the selected retailer or have the retailer send the items to them; and (e) optionally, providing payment information (e.g., credit or debit card information) that may be used to pay for the order; (6) the manufacturer, or the manufacturer's computer system, then sends a message to the retailer (which was specified by the student) indicating that the manufacturer has received a new order to process; (7) after receiving the message, the retailer logs on to the manufacturer's computer system and retrieves the new order; (8) the retailer then either processes the order (if the student has provided payment information and indicated that they wish to have the order sent directly to them), or contacts the student to coordinate completion of the order; and (9) after the order is completed, the retailer notifies the manufacturer that the order is complete and the manufacturer conveys a benefit to the benefitting party specified by the student. An example of a suitable benefit may be, for example, 5% of the purchase price of the student's completed order.

It should be understood that the various steps described above may vary in the context of different embodiments and that certain steps may be omitted and other steps may be added. Various particular examples are described below.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Exemplary System Architecture

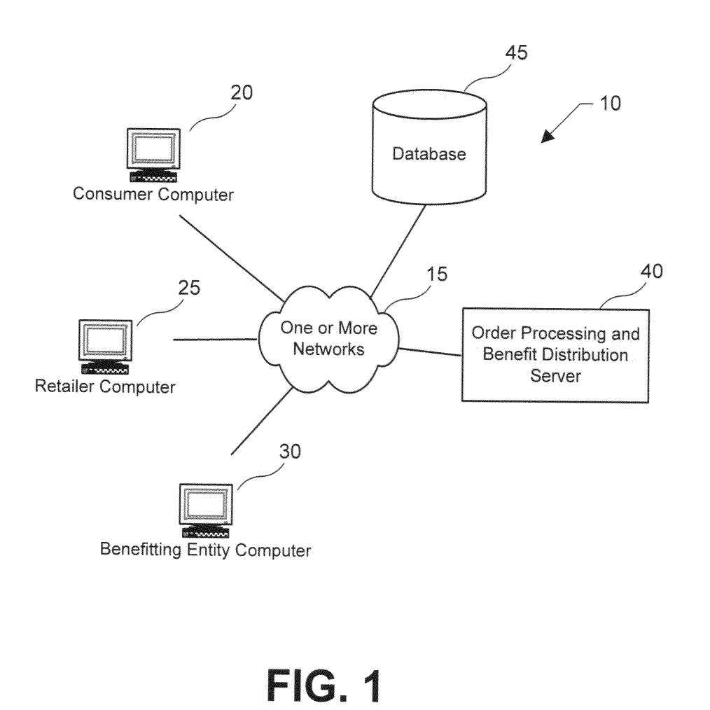

FIG. 1 shows a block diagram of an Ordering Processing System 10 according to a preferred embodiment of the present invention. As may be understood from this figure, the Order Processing System 10 includes an Order Processing and Benefit Distribution Server 40, one or more computer networks 15, a Database 45, at least one Customer Computer 20, at least one Retailer Computer 25, and at least one Benefitting Entity Computer 30. The one or more computer networks 15 facilitate communication between the Customer Computer 20, the Retailer Computer 25, and the Benefitting Entity Computer 30, the Database 45, and the Order Processing and Benefit Distribution Server 40. These one or more computer networks 15 may include any of a variety of types of computer networks such as the Internet, a private intranet, a public switch telephone network (PSTN), or any other type of network known in the art. In certain variations of the embodiment shown in FIG. 1, both the communication link between the Customer Computer 20, the Retailer Computer 25, and the Benefitting Entity Computer 30, and the Order Processing and Benefit Distribution Server 40 are implemented via the Internet using Internet protocol (IP). In certain embodiments, the communication link between the Order Processing and Benefit Distribution Server 40 and the Database 45 may be, for example, implemented via a Local Area Network (LAN).

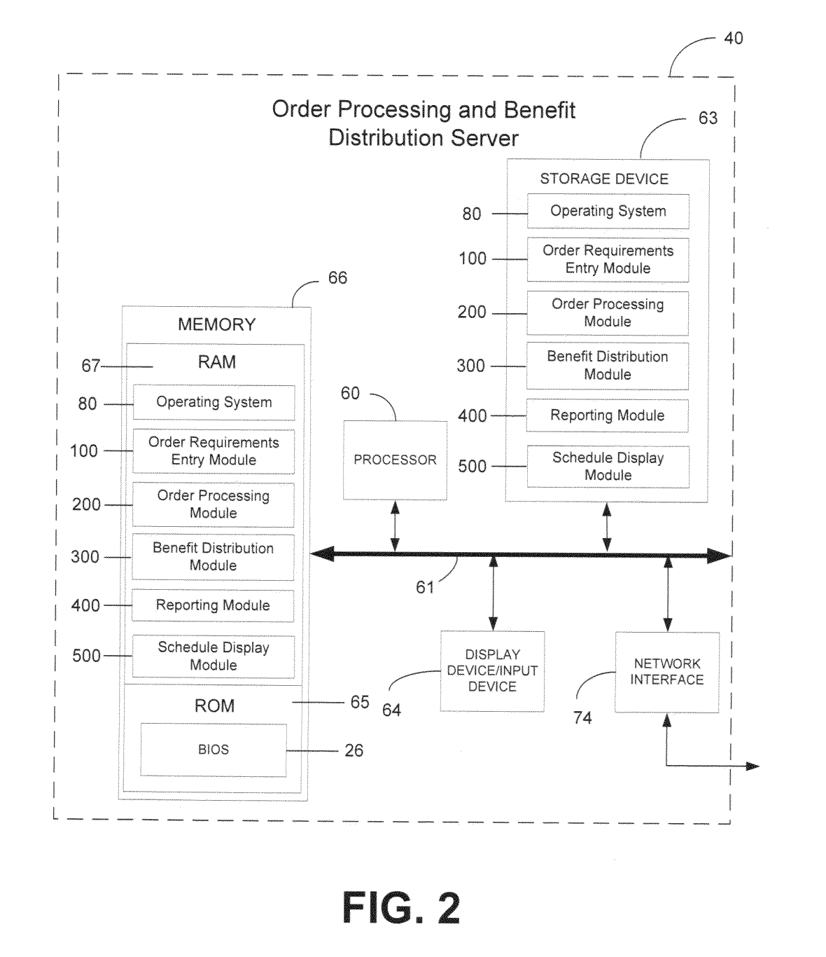

FIG. 2 is a block diagram of an exemplary embodiment of the Order Processing and Benefit Distribution Server 40 of FIG. 1. The Order Processing and Benefit Distribution Server 40 includes a processor 60 that communicates with other elements within the Order Processing and Benefit Distribution Server 40 via a system interface or bus 61. Also included in the Order Processing and Benefit Distribution Server 40 is a display device/input device 64 for receiving and displaying data. This display device/input device 64 may be, for example, a keyboard, voice recognition, or pointing device that is used in combination with a monitor. The Order Processing and Benefit Distribution Server 40 further includes memory 66, which preferably includes both read only memory (ROM) 65 and random access memory (RAM) 67. The server's ROM 65 is used to store a basic input/output system 26 (BIOS) that contains the basic routines that help to transfer information between elements within the Order Processing and Benefit Distribution Server 40.

In addition, the Order Processing and Benefit Distribution Server 40 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Order Processing and Benefit Distribution Server 40. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, an Order Requirements Entry Module 100, an Order Processing Module 200, a Benefit Distribution Module 300, a Reporting Module 400, and a Schedule Display Module 500. The Order Processing Module 200 and Benefit Distribution Module 300 control certain aspects of the operation of the Order Processing and Benefit Distribution Server 40, as is described in more detail below, with the assistance of the processor 60 and an operating system 80.

Also located within the Order Processing and Benefit Distribution Server 40 is a network interface 74 for interfacing and communicating with other elements of a computer network. It will be appreciated by one of ordinary skill in the art that one or more of the Order Processing and Benefit Distribution Server 40 components may be located geographically remotely from other Order Processing and Benefit Distribution Server 40 components. Furthermore, one or more of the components may be combined, and additional components performing functions described herein may be included in the Order Processing and Benefit Distribution Server 40.

### Exemplary System Modules

As noted above, various aspects of the Order Processing and Benefit Distribution System's functionality may be executed by certain system modules, including the system's Order Requirements Entry Module 100, Order Processing Module 200, Benefit Distribution Module 300, Reporting Module 400, and Schedule Display Module 500. These modules are discussed in greater detail below.

Order Requirements Entry Module

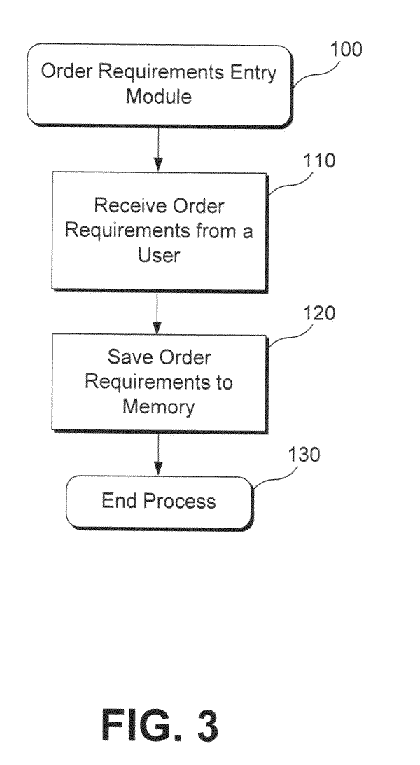

FIG. 3 is a flow chart of an exemplary Order Requirements Entry Module 100. As may be understood from this figure, certain embodiments of the Order Requirements Entry Module 100 are configured to allow the system to receive order requirements from a user. For example, beginning at Step 110, when executing the Order Requirements Entry Module 100, the system may receive, from a dance class instructor (or other individual associated with a dance school), one or more items recommended or required for purchase by one or more particular consumers. For a dance class, these items may be the various items that make up a uniform that is required for participation in the class. The items may also include tools and/or materials needed to complete a particular project. In various embodiments, the system may be configured to allow the user to enter a list of one or more retailers from which the consumer (e.g., a dance student in the dance instructor's class) may purchase the recommended or required items.

At Step 120, the system saves the order requirements to memory after receiving them. The system also preferably saves an order designation, such as a class title or number, associated with the order requirements to allow users to later search for and retrieve the order requirements.

Order Processing Module

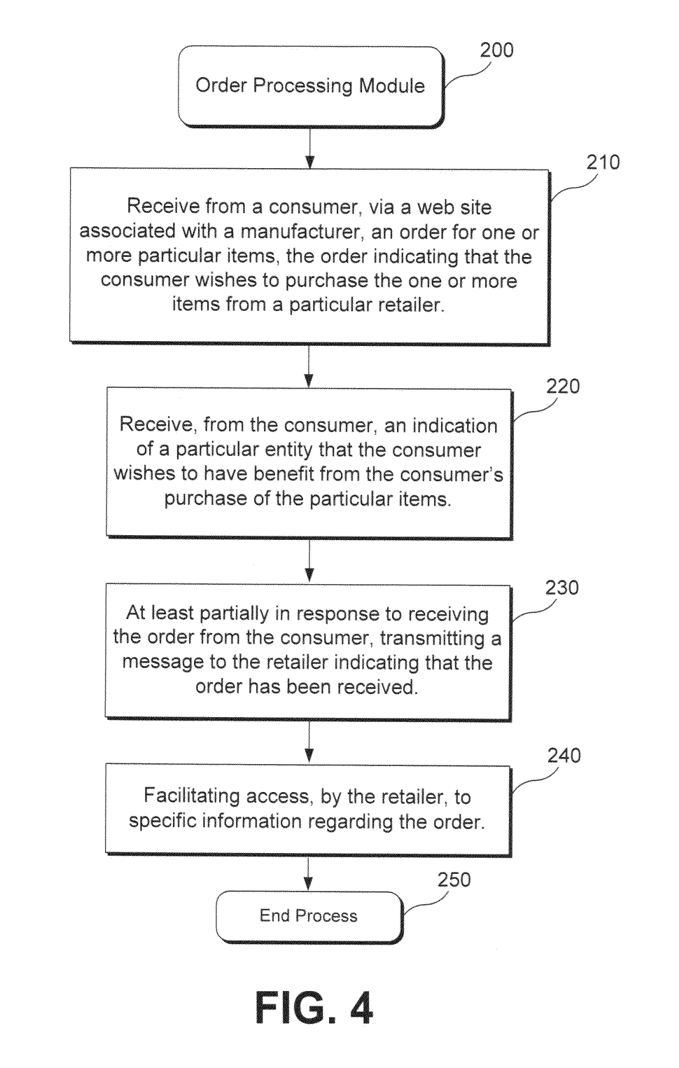

FIG. 4 is a flow chart of an exemplary Order Processing Module 200. As may be understood from this figure, certain embodiments of the Order Processing Module 200 are configured to allow consumers to place an order and to facilitate processing of the order by a retailer.

Beginning at Step 210, when executing the Order Processing Module 200, the system may receive an order from a consumer (e.g., via a web site associated with a manufacturer of one or more particular items), indicating that they wish to purchase the one or more items from a particular retailer. These may be items needed to fulfill requirements for a particular class, as specified at Step 110, which is discussed above. For example, a dance student may have used the system to access order requirements entered by the student's dance class instructor at Step 110. The order requirements may specify a list of items that make up the student's uniform for a particular performance and/or a list of one or more retailers from which students in the class may purchase the items.

In various embodiments, after the system displays the order requirements, the consumer may select (e.g. from a drop-down list) a particular retailer from which she would like to purchase the order. In particular embodiments, the system only allows the consumer to select from a list of retailers designated by the user (e.g., the consumer's dance instructor) at Step 110. In other embodiments, the system may be adapted to locate suitable retailers based on the consumer's location, which may be provided in any suitable manner by the consumer. In further embodiments, the order requirements received at Step 110 may specify a particular retailer from which all students (or other consumers) must purchase the recommended or required materials. In such a case, the consumer may not be provided the option of selecting a particular retailer to fulfill the order.

In various embodiments, the student may elect to have the order fulfilled by mail from the selected retailer or in-person at the selected retailer. Optionally, as part of Step 210, the system may allow the consumer to purchase items other than those specified in the order requirements.

Next, advancing to Step 220, the consumer specifies a particular entity that they wish to have benefit from their purchase of the items. This benefitting entity may be, for example, the consumer's dance school.

Next, at Step 230, at least partially in response to receiving the order from the consumer, the system transmits (e.g., automatically transmits) a message to the retailer that will be fulfilling the order (e.g., the retailer specified by the consumer at Step 210, or by the user at Step 110) indicating that the order has been received. This message may be, for example, an e-mail, text message, or any other suitable message.

At Step 240, the system facilitates retailer access to the information within the order. For example, the system may allow the retailer to log into the system (e.g., via a suitable secure web site) to retrieve their orders. Alternatively, the retailer may receive the order directly by e-mail or any other suitable method.

Upon receiving the order, the retailer may order the items from the manufacturer, or the system may automatically arrange for the manufacturer to send the items to the designated retailer upon the system's receipt of the order. The retailer may then fulfill the order directly (e.g., in situations where the consumer included, at Step 210, payment information, a mailing address, and directions for sending the order to the consumer). Alternatively, the retailer may contact the consumer (e.g., by phone, e-mail, or text messaging) to coordinate fulfillment of the order (e.g., through an in-person purchase at the retailer's store, or by mail delivery of the items to the consumer).

Benefit Distribution Module

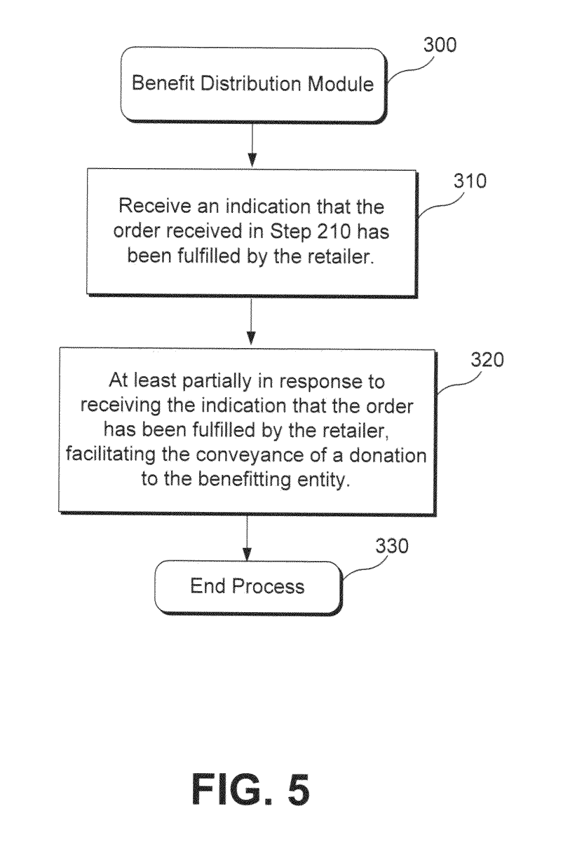

FIG. 5 is a flow chart of an exemplary Benefit Distribution Module 300. As may be understood from FIG. 5, certain embodiments of the Benefit Distribution Module 300 are configured to allow the system to notify the manufacturer that an order has been fulfilled by the retailer, and to facilitate conveyance of a donation (or other benefit) to the benefitting entity specified at Step 220.

In particular, at Step 310, the system receives an indication that the order has been fulfilled by the retailer. The system may receive this indication via an e-mail or phone call from the retailer, or by searching the system's database 45 for orders from the retailer that match the specified order criteria, or through any other suitable method.

At Step 320, at least partially in response to receiving the indication that the order has been fulfilled by the retailer, the system facilitates the conveyance of a donation (or other benefit) to the benefitting entity selected at Step 220. For example, the system may automatically generate a check that is to be sent to the consumer's dance school. The system may process the donation immediately or at any other suitable time. For example, in various embodiments, the system may process all donations in a single batch at the end of the day, week, month, quarter, or any other suitable time period.

Reporting Module

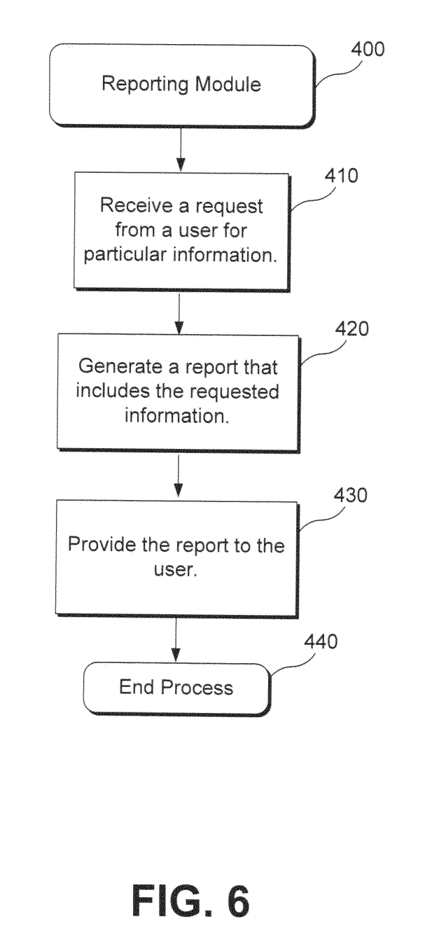

FIG. 6 is a flow chart of an exemplary Reporting Module 400. As may be understood from this figure, certain embodiments of the Reporting Module 400 are configured to allow the system to generate reports for a user. These reports may include any suitable information saved in the system's database 45. For example, the system may generate reports for schools that indicate, for example, items ordered through the system for the school's students, a summary of benefits that the school has received through a particular fundraising program, and/or the school's current class schedule.

The system may also generate suitable reports for retailers. Suitable reports include, for example, reports listing which schools have recommended the retailer to their students, or reports that summarize all orders received by the retailer through the system.

As another example, the system may generate a variety of different reports for the manufacturer. Such reports may, for example, indicate which schools and teachers are using the system, and the volume of business that each retailer is receiving through the system.

Turning again to FIG. 6, at Step 410, the system receives a request from a user for particular information. For example, a retailer may wish to know which schools or school representatives have recommended the retailer to satisfy uniform order requirements specified by representatives of the school. At Step 420, the system generates a report that includes the requested information. For example, the system may compile a list of schools that recommended the retailer when the school set up its various class order requirements. Finally, at Step 430, the system provides the report to the user (e.g., in the form of an on-screen listing, paper printout, or any other suitable report).

Schedule Display Module

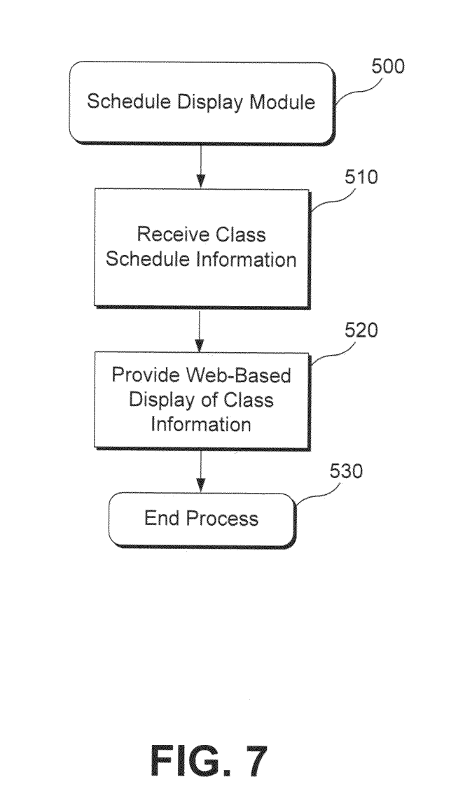

FIG. 7 is a flowchart of an exemplary Schedule Display Module 500. As may be understood from this figure, certain embodiments of the Schedule Display Module 500 are configured to allow the system to generate a display of a school's schedule of classes.

More particularly, at Step 510, the system receives a schedule of class and event information (e.g., from a school representative). For example, a school may set up a schedule of all classes and events for the coming semester. This schedule may include, for each class or other event: (1) the name of the class or event; (2) the instructor's name; (3) the instructor's e-mail address; (4) a brief description of the class or event; (5) the date(s) of the class or event; and/or (6) the time for which the class or event is scheduled.

At Step 520, the system provides a display of the class schedule information on a web page. For example, a particular school's full class schedule may be displayed as a scrolling display that may be displayed on any computer screen with internet access (e.g., via a dedicated web page maintained by the manufacturer). In particular embodiments, this may allow a school to always display an updated class schedule without having to enter their class schedules into a separate system and without having to maintain a separate computer program for class schedule displays.

### Exemplary User Interface

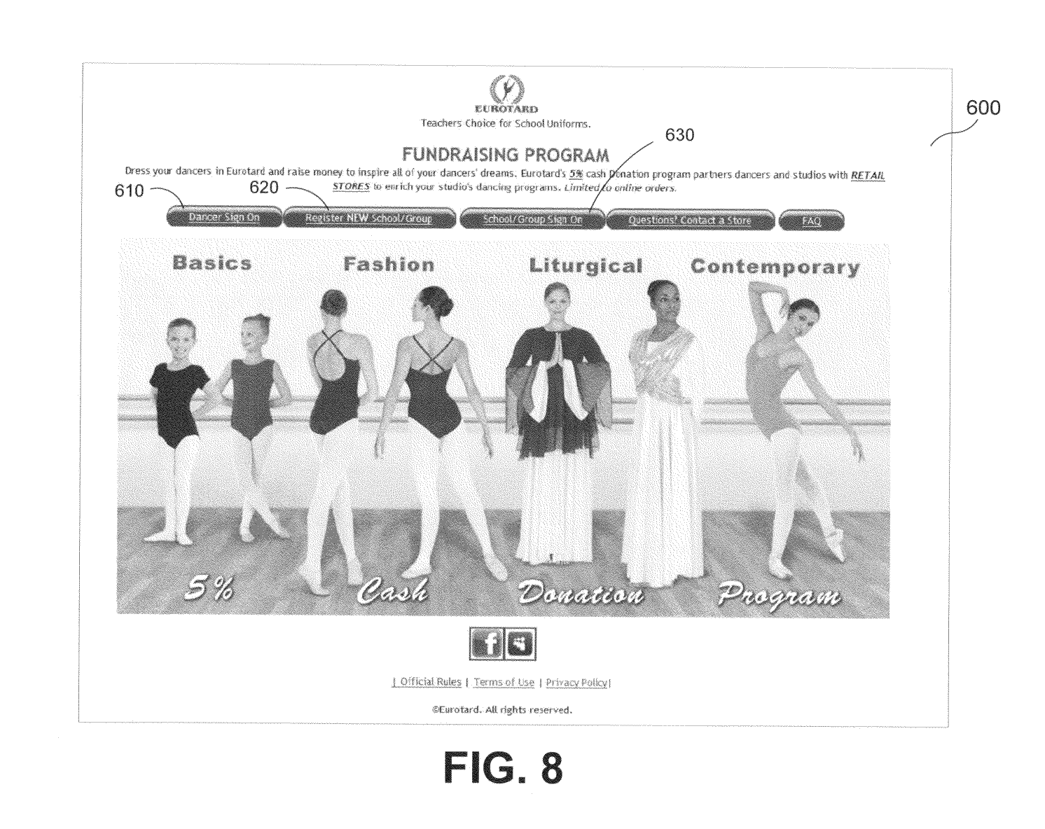

An exemplary user interface for a particular embodiment is shown in FIGS. 8-13, which depict a series of web-based user interface screens. For example, FIG. 8 shows an example of a fundraising program home screen 600. This screen includes: (1) a Dancer Sign On button 610 that enables consumers to sign on to the system to view uniform requirements; (2) a Register New School/Group button 620 that previously unregistered schools and groups can use to set up profiles and uniform requirements; and (3) a School/Group Sign On button 630 that schools can use to log on to the system to set up class requirements and create class schedules.

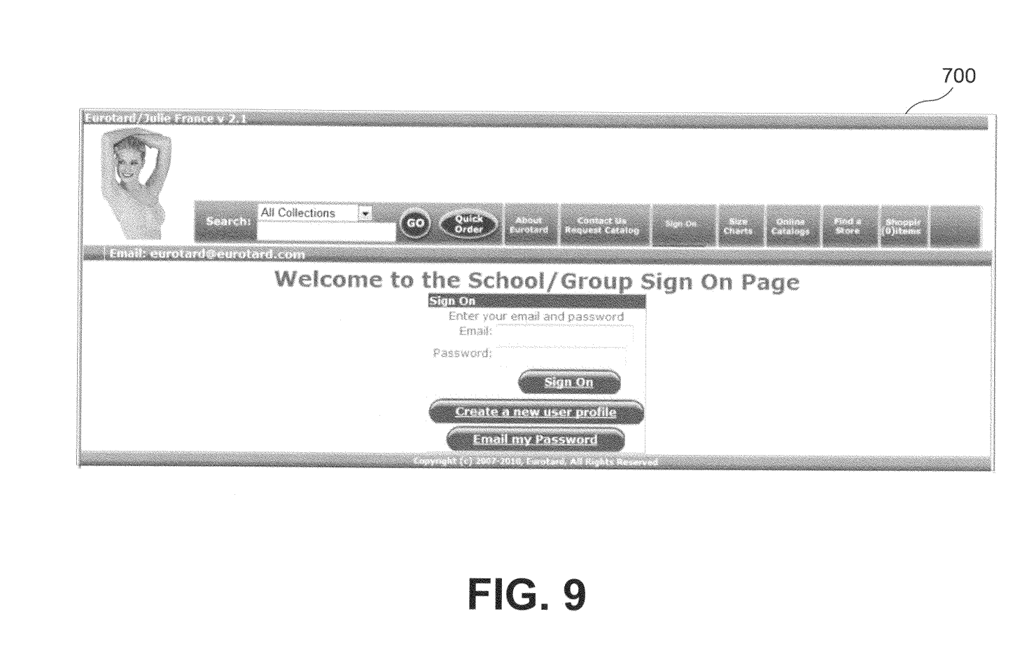

FIG. 9 shows an example School/Group Sign On screen 700, which is displayed after the user selects the School/Group Sign On button 630 and provides email and password information to log on to the site.

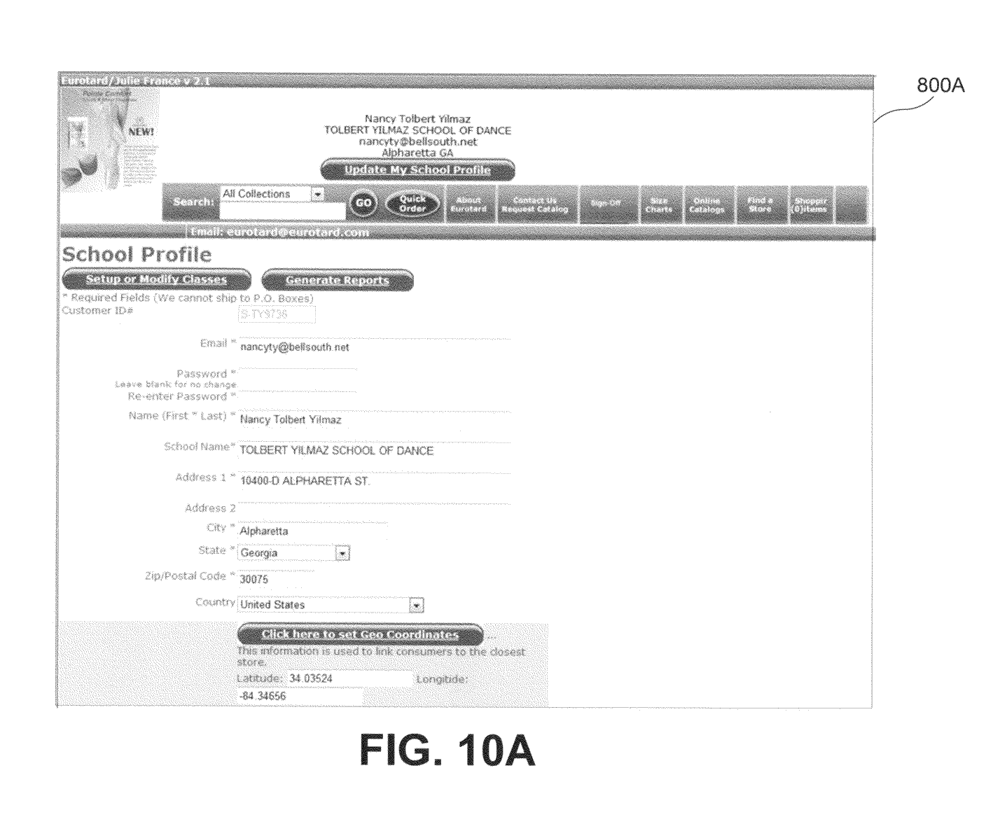

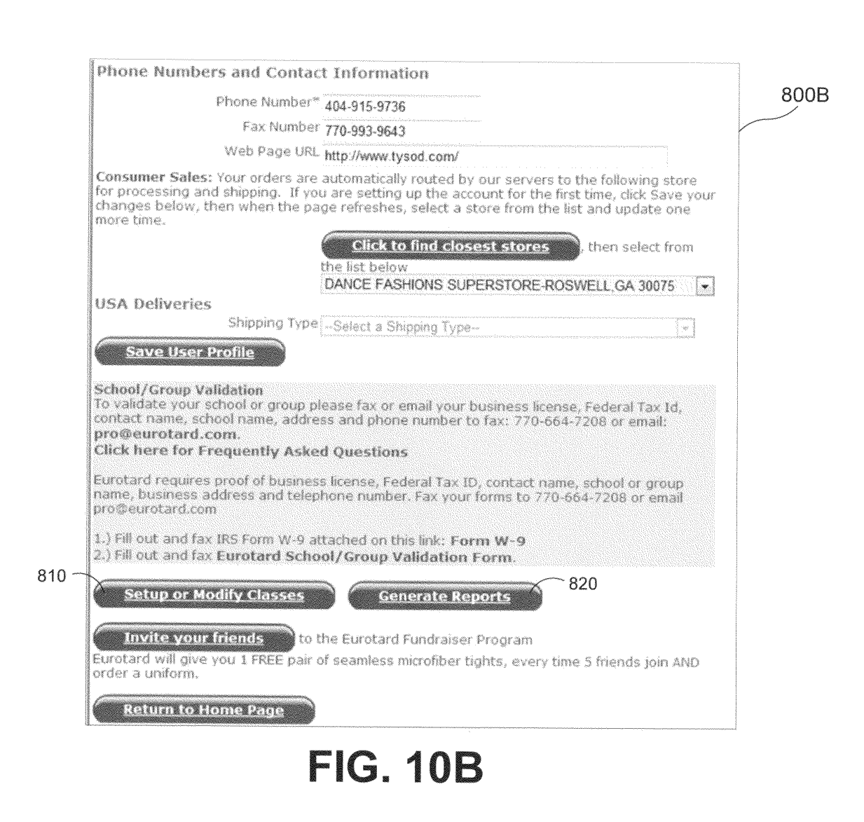

FIG. 10A shows the top portion of an exemplary School Profile screen 800A. The user receives this screen after signing on to the system via the School/Group Sign On screen 700. On this screen, users can setup new or modify existing class schedules and generate reports. Users can also set up new or change their existing basic profile information, such as their email address, password, name, school name, and address. The user can also specify the school's geographic coordinates in order to assist consumers in selecting the closest retailer to the school.

FIG. 10B is a lower portion of the School Profile screen 800B. On this portion of the screen, users can use the Setup or Modify Classes button 810 to setup new or modify existing class schedules, and use the Generate Reports button 820 to generate reports from existing information in the system's database 45. Users can also enter the school's phone number, fax number, and school web page address. Users can determine the retailers closest to the school and set a list of retail stores that will appear to consumers who use the system to order the school's uniforms. Users can save new or changed profiles.

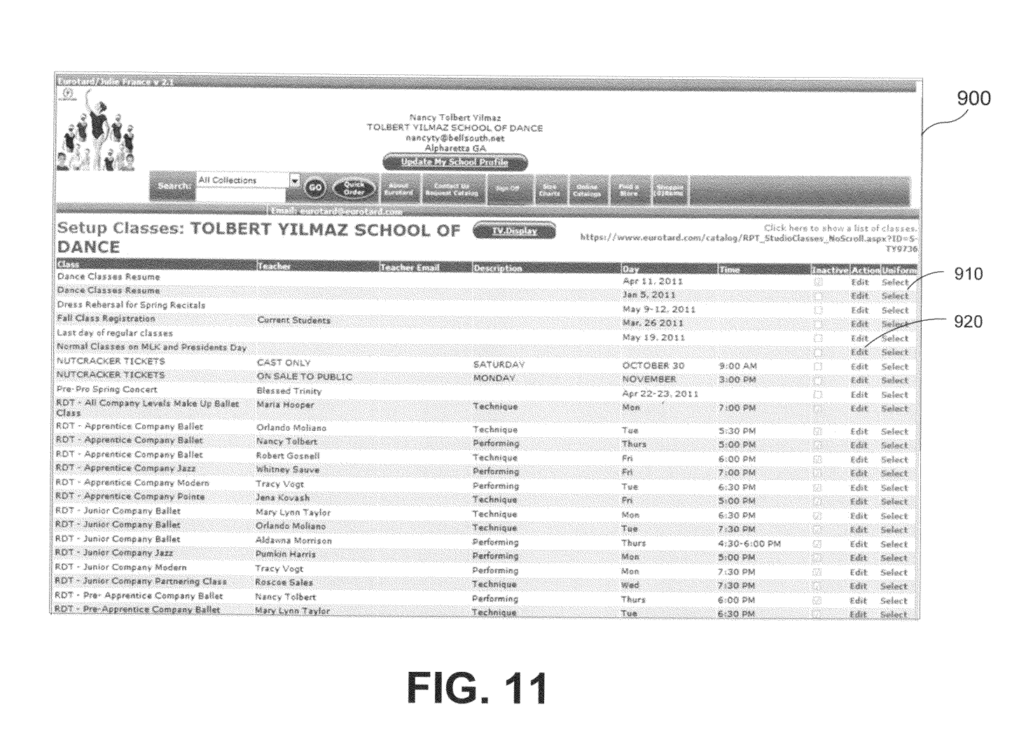

FIG. 11 shown an example of a Class Setup screen 900. User (e.g., dance instructors) can use this screen to set up class schedules using the Edit button 920. In addition, they may specify their class uniform requirements using the Select button 910.

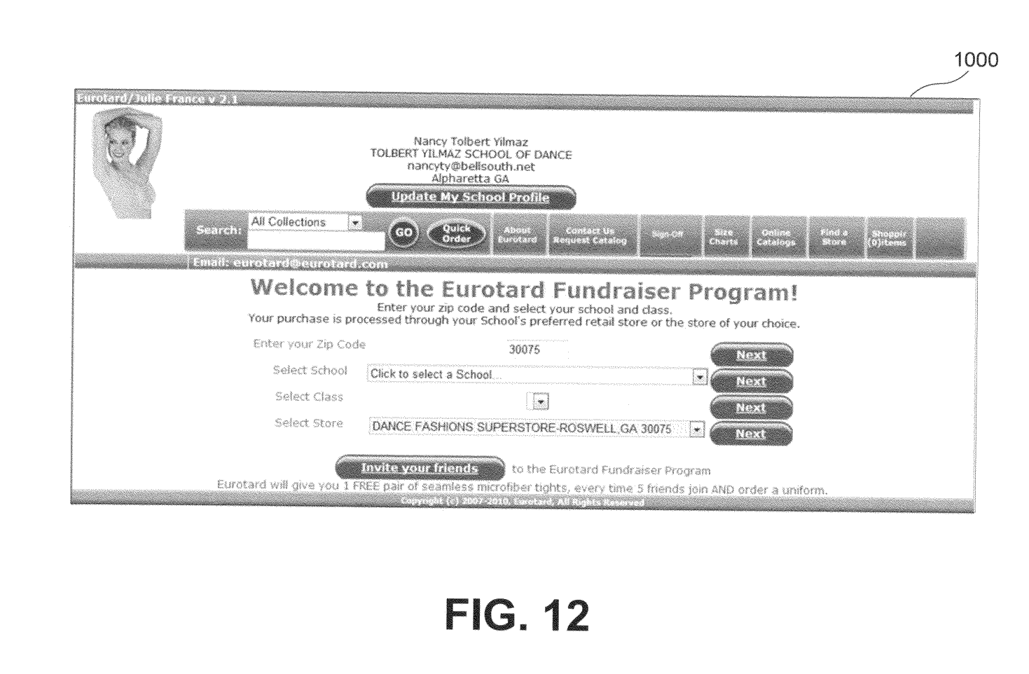

FIG. 12 is the Dancer Login screen 1000. Students use this screen to select school, class, and preferred retail store. After the student enters this information, the system displays a list of uniform requirements as entered by the student's class instructor. Students may place orders from this screen.

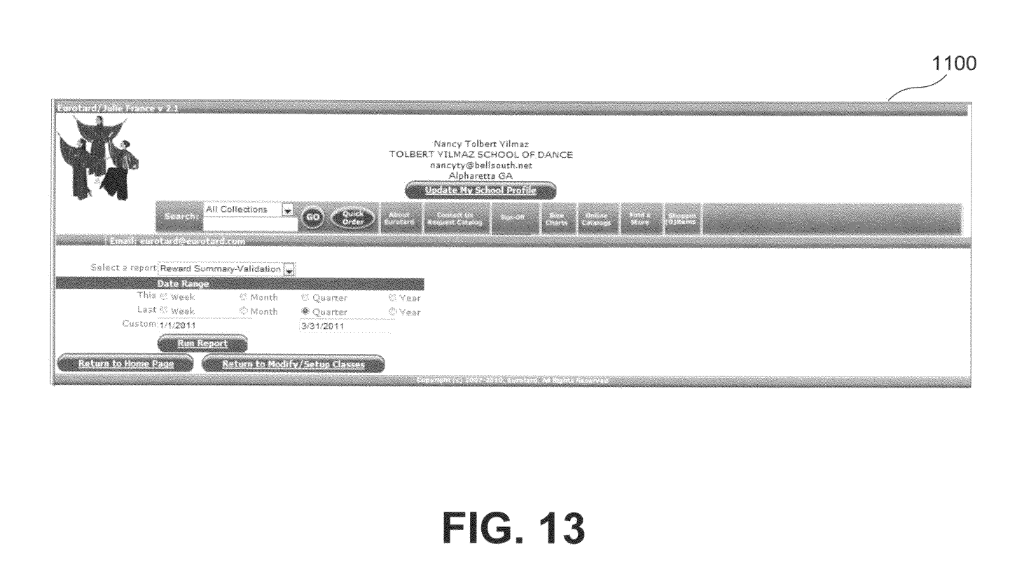

FIG. 13 shows the Benefit Reporting screen 1100. This screen enables schools to track benefits received by week, quarter, year, or within a custom date range.

### Example

The operation of exemplary embodiments of the Order Requirements Entry Module 100, Order Processing Module 200, Benefit Distribution Module 300, Reporting Module 400 and Schedule Display Module 500 are perhaps best understood by reviewing particular examples. The following examples describe the experience of a dance instructor, dance school student, retailer, and manufacturer when using various embodiments of the system to process orders for dance supplies.

Dance Instructor Experience

Nancy is an instructor at the Tolbert Yilmaz School of Dance. It is August and a new semester is about to begin at the dance school. In preparing for the upcoming semester, Nancy must select uniforms for her students to wear during class practice and for the class' formal recital in December. Nancy uses her school's computer (a “benefitting entity” computer 30) to log onto the website of a manufacturer of dance products (e.g., Eurotard's web site) to select the various items that will make up her class uniforms. After browsing many products, Nancy decides that the students in her class should wear, as their class uniform, a black leotard and pink tights for practice, and a periwinkle leotard with matching periwinkle tights, wrap skirt, and bun scrunchie for the December recital.

Nancy then proceeds to the fundraiser home screen 600 (see FIG. 8) to enter her uniform requirements into the manufacturer's system. To begin this process, Nancy clicks the School/Group Sign On button 630 (FIG. 8). The School/Group Sign On screen 700 (see FIG. 9) then opens and Nancy enters her e-mail address and password to sign in. The School/Group screen 900 (see FIG. 11) then opens. Nancy scrolls through the School/Group Screen 900 and finds her class. She then clicks the “Select” link 910 in the “uniform” column for her class. Nancy then selects the items that she has chosen for her class' recital uniforms and specifies the Dance Fashions Superstore as the retailer from which students should purchase their uniforms, as this store is the closest to the Tolbert Yilmaz School of Dance. The system then saves Nancy's selections to system memory. During the first meeting of her dance class, Nancy tells her students that the class' uniform requirements are listed on Eurotard's web site.

Dance School Student Experience

Susie is a student at the Tolbert Yilmaz School of Dance. Her class instructor is Nancy. As noted above, on the first day of class in the new semester, Nancy informs her students that they may see and purchase all items that make up their required class uniform on the manufacturer's website. After class, Susie uses her computer (which is an example of the customer computer 20 shown in FIG. 1) to go online to the manufacturer's fundraiser home screen (see FIG. 8). When the fundraiser home screen is displayed, Susie then clicks the Dancer Sign On button 610. Susie doesn't have an account yet, so she creates one and then proceeds to the dancer login screen (FIG. 12). Susie enters her zip code, selects the Tolbert Yilmaz School of Dance from the school drop-down list, and selects Nancy's class. The system then displays a list of uniform requirements for Nancy's class.

Susie decides to purchase all of the items specified by Nancy as uniform requirements for Nancy's class. Susie also decides that she would like to purchase a new black wrap skirt that is not part of the required uniform for Nancy's class. Susie selects all of the specified class uniform items and the black wrap skirt and the system adds these items to Susie's current order. Susie then selects Dance Fashions Superstore as the retailer from which she would like to purchase the items.

If Susie wished to use a credit card to pay for her order, she could enter her credit card number on this screen. However, she decides that she would rather pick up her items and pay in person at the Dance Fashions Superstore, so she does not enter a credit card number at this time. Susie then selects the Tolbert Yilmaz School of Dance as the entity to receive a benefit from her purchase. Feeling that her order is complete, Susie clicks a Submit button and the order is saved to the system's memory. The system then generates a message to Dance Fashions Superstore to let them know that they have received a new order.

Retailer Experience

Mike works at the Dance Fashions Superstore. He receives an e-mail message on the Retailer Computer 25 indicating that his store has received a new order. Mike uses the Retailer Computer 25 to log on to the manufacturer's website. After Mike log's on to the manufacturer's web site, he sees a list of all of Dance Fashion's new orders, including the order that Susie submitted. Mike selects Susie's order, and the system displays the order's contents. Mike confirms that all of the items in the order are in stock at the store, except for pink tights in Susie's size.

Mike then orders the pink tights from Eurotard. Mike notes that Susie did not include a credit card number with her order. He calls Susie to confirm the order and to notify her that the items will be available for pickup at Dance Fashions Superstore on Friday. If Susie had supplied a credit card number and a request to have her items shipped to her from Dance Fashions Superstore, Mike would call her to confirm the order shipping date. Alternatively, Mike could also contact Susie by e-mail, text message, Facebook message, etc. to confirm the order and coordinate fulfillment of the order. Mike then calls Eurotard to let them know that Susie's order has been fulfilled. Alternatively, Mike could also send a message to Eurotard to inform them that the order has been fulfilled. In other embodiments, the system may be configured to automatically generate a follow-up message to the retailer within a predetermined number of days after the order was initially received, requesting confirmation that the order has been fulfilled. As a further alternative, the system may automatically analyze information from within the system's database 45 to determine that the order has been fulfilled.

Manufacturer Experience

After Eurotard (and/or the system) receives confirmation that Dance Fashions has completed the order, Eurotard (and/or the system) facilitates the transfer of a benefit to the party that was designated as the party that would benefit from the related purchases (in this case, the Tolbert Yilmaz School of Dance). As a particular example, the system may be adapted to facilitate an electronic transfer of funds in the amount of 5% of the purchase price of all items in the consumer's order to the benefitting entity (the Tolbert Yilmaz School of Dance) in response to receiving confirmation that the order has been completed by the retailer.

Eurotard may also use the system to monitor orders placed by students, and also view other types of information, such as which schools and classes are using the system and which retailers those schools/classes selected as preferred retailers. In various embodiments, the manufacturer (in this case Eurotard) does not process orders directly, and does not handle any money associated with fulfilling the orders. Instead, the manufacturer only forwards orders to the retailer for processing. In other embodiments, the manufacturer may process some or all orders directly.

The manufacturer's representatives may be actively involved in confirming the completion of orders, or the system may do this automatically.

Benefitting Entity Experience

Because Susie selected the Tolbert Yilmaz School of Dance as the benefitting entity for her purchase, as discussed above, Eurotard will donate a benefit (e.g., a monetary donation) to the school. In particular embodiments, this benefit may be used by the benefitting party in any way that the benefitting party sees fit. For example, it may use any monetary donations to sponsor talented, economically disadvantaged students, or to cover costs associated with the school's performances.

Class Schedule Displays

Continuing with the example above, the Tolbert Yilmaz School of Dance decides that it would be beneficial to set up an electronic class schedule in the school's lobby. The school's computer specialist realizes that the easiest way to do this is to simply: (1) connect a computer with internet access to a computer monitor in the school's lobby; (2) use the computer's Internet browser to log onto Eurotard's website; and (3) select a TV Display button 930 from the school's class setup screen. In response to this button being selected, the system will display a full schedule of the school's classes and events that are entered into the system. In various embodiments, the system updates this schedule automatically, at least substantially in real time, to reflect any updates made to the schedule within the system. In particular embodiments, the manufacturer may display advertisements or other messages along with the class schedule.

### Conclusion

Many modifications and other embodiments of the invention will come to mind to one skilled in the art to which this invention pertains having the benefit of the teachings presented in the foregoing descriptions and the associated drawings. While examples discussed above cover the use of the system in the context of dance-related purchases, the system may be used in any other suitable context. For example, certain systems may be used in the context of other types of classes, such as karate classes, sewing classes, or any other type of class. As another example, various exemplary embodiments may be used in the context of purchases for non-educational groups, such as religious groups (e.g., choir groups) and dance groups. Within such contexts, some examples of benefitting entities may include a church, a choir group, a dance group, or any other suitable benefitting entity. Also, the system may be used in the context of any type of purchase. For example, the system may be used in the context of purchases of casual wear, undergarments, or any other suitable purchase. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for processing an order for a particular item that is made by a manufacturer and sold by a retailer, said computer system comprising:
memory, and
at least one computer processor, wherein said computer system is adapted for executing the steps of:
(A) receiving, from a representative of a school, a list of one or more items to be used by a student within a particular class as part of said student's involvement with said particular class, said particular class being offered by said school;
(B) saving said list of items to memory;
(C) displaying said list of one or more items to a purchaser who wishes to purchase said one or more items;
(D) allowing said purchaser to place an order for said one or more items;
(E) receiving information regarding a benefitting party, said benefitting party being a party who will receive a benefit as a result of said purchaser purchasing said one or more items;
(F) transmitting a message to a designated retailer indicating that said purchaser has placed said order;
(G) allowing said designated retailer to access information regarding said order so that said retailer may fulfill said order;
(H) receiving an indication that said retailer has fulfilled said order; and
(I) at least partially in response to receiving said indication that said retailer has fulfilled said order, facilitating a transfer of said benefit to said benefitting party.

2. The computer system of claim 1, wherein said computer system is further adapted for displaying said list of items in response to receiving a request to display required materials for said particular class.

3. The computer system of claim 1, wherein said computer system is further adapted for allowing said purchaser to designate said designated retailer as the retailer that will fulfill said order.

4. The computer system of claim 3, wherein said computer system is adapted for allowing said purchaser to designate said retailer by:
displaying a list of retailers; and
allowing said purchaser to select a particular retailer from said list of retailers.

5. The computer system of claim 4, wherein said computer system is further adapted for allowing a representative of said school to provide said list of retailers.

6. The computer system of claim 1, wherein said computer system is further adapted for allowing a representative of said school to designate said designated retailer as the retailer that will fulfill said order.

7. The computer system of claim 1, wherein said Steps (A)-(G) are executed by one or more computers associated with a manufacturer of said one or more items.

8. The computer system of claim 7, wherein said benefitting entity is said school.

9. The computer system of claim 8, wherein said computer system is further adapted for allowing said purchaser to specify said benefitting entity.

10. The computer system of claim 1, wherein said one or more items comprise a plurality of items that make up a class uniform.

11. The computer system of claim 10, wherein:
said uniform is a dance uniform; and
said class is a dance class.

12. A computer system for processing an order for a particular item that is made by a manufacturer and sold by a retailer, said computer system comprising:
memory, and
a processor, wherein said computer system is adapted for:
receiving from a consumer, via a web site associated with said manufacturer, said order for said particular item, said order indicating that said consumer wishes to purchase said particular item from said retailer;
receiving, from said consumer, an indication of a particular benefitting entity that said consumer wishes to have benefit from said consumer's purchase of said particular item;
at least partially in response to receiving said order from said consumer, transmitting a message to said retailer indicating that said order has been received;
facilitating access, by said retailer, to specific information regarding said order;
receiving an indication that said order has been fulfilled by said retailer; and
at least partially in response to receiving said indication that said order has been fulfilled by said retailer, facilitating a conveyance of a benefit to said benefitting entity.

13. The computer system of claim 12, wherein:
said computer system is adapted for storing said specific information regarding said order on a computer that is associated with said manufacturer; and
said step of facilitating access, by said retailer, to specific information regarding said order comprises allowing said retailer to access said specific information regarding said order on said computer that is associated with said manufacturer.

14. The computer system of claim 12, wherein said computer system is further configured for:
receiving information, from said benefitting entity, regarding which items make up a particular uniform for a particular class, wherein said particular item is one of said items that make up said particular uniform;
after receiving said information from said benefitting entity, allowing said consumer to enter a request for a list of items that comprise said uniform for said particular class;
at least partially in response to said consumer entering said request, displaying said list of items that make up said uniform; and
after displaying said list of items that make up said uniform, allowing said consumer to place said order for said particular item.

15. The computer system of claim 12, wherein said benefit is a monetary donation.

16. The computer system of claim 12, wherein said computer system is further adapted to allow said consumer to indicate whether said consumer wishes to pick up said particular item from said retailer, or to have said particular item shipped directly from said retailer to said consumer.

17. The computer system of claim 12, wherein:
said benefitting entity is a school of dance;
said manufacturer is a manufacturer of dance supplies; and
said retailer is a retailer of dance supplies.

18. A computer-implemented method of distributing a benefit to a benefitting entity, said method comprising the steps of:
(A) receiving, from a school representative, a list of one or more items to be used by a student within a particular class as part of said student's involvement with said particular class, said particular class being offered by said school;
(B) saving said list of items to computer memory;
(C) displaying said list of one or more items to a purchaser who wishes to purchase said one or more items for an individual who is taking said particular class;
(D) allowing said purchaser to place an order for said one or more items;
(E) receiving information regarding a benefitting party, said benefitting party being a party who will receive a benefit as a result of said purchaser purchasing said one or more items;
(F) transmitting a message to a designated retailer indicating that said purchaser has placed said order;
(G) allowing said designated retailer to access information regarding said order so that said retailer may fulfill the order;
(H) receiving an indication that said retailer has fulfilled the order; and
(I) at least partially in response to receiving said indication that said retailer has fulfilled said order, facilitating a transfer of a benefit to said benefitting party.

19. The method of claim 18, wherein said Steps (A)-(G) are executed by one or more computers associated with a manufacturer of said one or more items.

20. The method of claim 18, wherein:
said benefitting entity is a school of dance;
said manufacturer is a manufacturer of dance supplies; and
said retailer is a retailer of dance supplies.

21. The method of claim 18, wherein said purchaser is said individual who is taking said particular class.
